(19) United States
(12) Patent Application Publication
(10) Pub. No.: US 2025/0086575 A1
(43) Pub. Date: Mar. 13, 2025

(54) System, Apparatus and Method for Delivery of Goods to Purchasers

(71) Applicant: T.K. International Corp., Honolulu, HI (US)

(72) Inventors: Marcelo J Grasso, Sr., Salisbury, MD (US); Marcelo J Grasso, II, Smyrna, DE (US); Joshua A Russo, Hutto, TX (US)

(21) Appl. No.: 18/244,911

(22) Filed: Sep. 11, 2023

Related U.S. Application Data
(60) Provisional application No. 63/405,376, filed on Sep. 9, 2022.

(51) Int. Cl. G06Q 10/0835

(52) U.S. Cl. CPC G06Q 10/08355; G06Q 10/0838

(57) ABSTRACT

System, apparatus and method for coordinating delivery of goods to a consumer. The disclosed invention facilitates and coordinates this interaction. The disclosed invention for facilitating delivery requests comprises receiving a request for delivery wherein the delivery request comprises delivery parameters, analyzing delivery parameters to determine prospective deliverers, routing the delivery request to prospective deliverers for acceptance, upon acceptance by a deliverer, monitoring performance of the delivery by the deliverer.

### CROSS REFERENCE TO RELATED APPLICATIONS

This application claims priority from provisional U.S. patent application No. 63/405,376 filed on Sep. 9, 2022.

### FIELD OF THE INVENTION

Embodiments of the invention relate to the delivery of goods to purchasers.

### BACKGROUND OF THE INVENTION

Goods are more and more being purchased through online stores or websites rather than in stores. This requires goods to be delivered to a person's home or other location. Delivery of purchased goods to consumers is a significant business. A variety of delivery services have grown in popularity over the last decade. However, the general focus of the delivery services is to facilitate the delivery of goods purchased through the delivery provider's website. Even many of the popular delivery services that rely on ‘crowd sourcing’ the deliverers still require the purchase of food or other goods through their portal. They do not exist as a standalone delivery site where delivery of goods can be scheduled or performed on demand. Further, because such delivery services only provide delivery for the specific goods they provide through the delivery provider's website, they intentionally limit the delivery of goods to only the goods that they provide and know that every one of their deliverers will be capable of delivering. Therefore, a need exists for an improved system to coordinate the delivery of goods to purchasers.

### SUMMARY

System, apparatus and method for coordinating delivery of goods to a consumer. The disclosed invention facilitates and coordinates this interaction. The disclosed invention for facilitating delivery requests comprises receiving a request for delivery wherein the delivery request comprises delivery parameters, analyzing delivery parameters to determine prospective deliverers, routing the delivery request to prospective deliverers for acceptance, upon acceptance by a deliverer, monitoring performance of the delivery by the deliverer. The delivery parameters can include the goods to be delivered, the pickup location, and the delivery location. The delivery parameters can be determined from user entry, a confirmation communication, or combinations thereof. There prospective deliverers can be determined from the delivery parameters and deliverer information stored in the system, which can include geographic location and range and delivery vehicle, delivery team members, and tools

### BRIEF DESCRIPTION OF THE DRAWINGS

The accompanying drawings taken in conjunction with the detailed description will assist in making the advantages and aspects of the disclosure more apparent.

FIG. 1 is an embodiment of a delivery system embodiment.

FIG. 2 is the process of receiving a delivery request from a user.

FIG. 3 is the process of determining prospective deliverers.

FIG. 4 is a delivery process performed by delivery system embodiment.

### DETAILED DESCRIPTION

Reference will now be made in detail to the present embodiments discussed herein, illustrated in the accompanying drawings. The embodiments are described below to explain the disclosed method, system, apparatus, and program by referring to the figures using like numerals.

The subject matter is presented in the general context of program modules and/or in computer hardware, including the structures disclosed in this specification and their structural equivalents, or in combinations of one or more of them. Those skilled in the art will recognize that other implementations may be performed in combination with other types of program and hardware modules that may include different data structures, components, or routines that perform similar tasks. The invention can be practiced using various computer system configurations and across one or more computers, including, but not limited to, clients and servers in a client-server relationship. Computers encompass all kinds of apparatus, devices, and machines for processing data, including by way of example one or more programmable processors, memory, and can optionally include, in addition to hardware, computer programs and the ability to receive data from or transfer data to, or both, mass storage devices. A computer program, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers.

Unless otherwise defined, all terms (including technical and scientific terms) used herein have the same meaning as commonly understood by one having ordinary skill in the art to which this invention belongs. In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. The specification and claims should be read with the understanding that such combinations are entirely within the scope of the invention and the claims.

It will nevertheless be understood that no limitation of the scope is thereby intended, such alterations and further modifications in the illustrated invention, and such further applications of the principles as illustrated therein being contemplated as would normally occur to one skilled in the art to which the embodiments relate. The present disclosure is to be considered as an exemplification of the invention, and is not intended to limit the invention to the specific embodiments illustrated by the figures or description below.

System, apparatus and method for coordinating delivery of goods to a consumer. Such an invention allows a consumer of goods, a user, to submit a request for the pickup and delivery of one or more goods from one or more sources. Upon receipt of the request for pickup and delivery, the system identifies one or more prospective deliverers capable of performing the delivery and routes the request to the deliverers. This process of identifying the prospective deliverers is done according to deliverer profiles, the delivery request, and consumer preferences. A deliverer accepts the delivery request and its terms and performs the pickup and delivery of the goods to the user or a designated location. The disclosed invention facilitates and coordinates this interaction. A user, as defined in this disclosure, is a person utilizing the system to receive a delivery of goods while a deliverer, as defined in this disclosure, is a person utilizing the system to perform a delivery of goods. In a single delivery, a person is either a user or a deliverer.

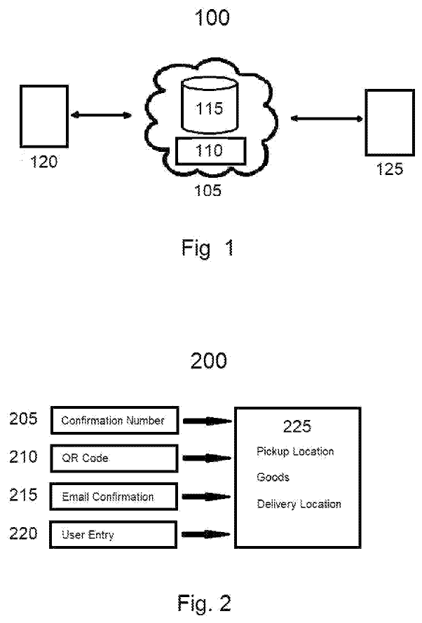

The disclosed system in FIG. 1 comprises one or more cloud servers 105 and one or more client computing devices 120, 125. The cloud server includes a database 110 or other storage means for storing user and deliverer information, delivery request, acceptance, and performance information, and other system information and analytics. A routing processor 115 for managing requests, routing them to deliverers, and managing the performance of deliveries running on the cloud server performs the disclosed processes. A system administrator with direct access to the cloud server can maintain the data stored in the cloud server.

A user interacts with the system using an application or web browser running on a user's client computing device 120. Usable client computing devices include, but are not limited to, a personal computer, smartphones, tablets, connected entertainment devices, digital media players, and wearable/implants (computing devices integrated with the human body). Such computer devices may include one or more processors, data storage in the form of memory (hard disk, non-volatile solid state memory, random access memory, cache memory, etc.), a computer operating system (“OS”) and network connectivity.

A deliverer interacts with the system using an application or web browser running on a deliverer's client computing device 125. Usable client computing devices include, but are not limited to, sa personal computer, smartphones, tablets, connected entertainment devices (such as smart tvs), digital media players, and wearable/implants (computing devices integrated with the human body). Such computer devices may include one or more processors, data storage in the form of memory (hard disk, non-volatile solid state memory, random access memory, cache memory, etc.), a computer operating system (“OS”) and network connectivity.

A deliverer client application or interactive web interface provides a deliverer a means to register as a deliverer. This includes an interface to provide information about the deliverer, including but not limited to personal identification information, communication preferences, the delivery vehicle utilized, geographical location and range, delivery tools and equipment, professional background, licenses and insurance. The deliverer information submitted through the deliverer client is sent to and securely stored on the cloud server. Deliverers undergo a vetting process whereby background and compliance checks are performed by the system using the submitted information. Successful registration results in a deliverer's submitted information being used to generate whereby the deliverers submitted information will be used to match optimal prospective deliverers with delivery requests. If needed, the deliverer client application can assist the deliverer in meeting the requirements for registration including but not limited to, applying for insurance and licensure or purchasing or renting delivery tools and equipment.

A client application or interactive web interface provides a user a means to request a pickup and delivery of goods. Because purchases are not made through the disclosed system, a user submits a delivery request to the system. Registration of a user on the client application, although preferred, is not required to request a pickup and delivery. Although specific situations may vary, a typical user is someone who has purchased goods from a source (retailer), has selected store pickup, and needs someone to deliver the goods to a location. A typical request includes as parameters: the goods/order, the pickup location, and the delivery location. In the preferred embodiment, communication means and preferences to enable communication with users by a system administrator or a deliverer are required. As illustrated in FIG. 2, the user interface allows for various means (alone or in combination) for the user to submit the delivery parameters 225 as part of a request 200, and no limitation is intended.

A confirmation number (or confirmation code) is an alphanumeric identifier commonly provided by the source after the purchase of goods. The disclosed system can be configured to receive a confirmation number 205 and a user entered string 220 identifying the source of the goods. With the confirmation number, a lookup of the order with the source, through the source's website or other portal, can identify the goods and the pickup location and populate these parameters in a request.

The source may alternatively generate a QR code, which can contain identifying and locational information. The disclosed system can be configured to receive a QR code 210 which would contain information identifying the goods and source and/or pickup location and populate these parameters in a request.

Users often receive other communications or confirmations of their purchases from the source. The system can be configured to receive from the user such communications, such as an email confirmation 215, that the user has forwarded. The system can extract information from the communication, which can include the goods, source and/or pickup location and populate these parameters in a request.

The user can manually submit information about the goods and pickup location manually 220 through the user interface when other means are not available. This would be commonly for more informal goods pickups, such as those through classifieds websites, and this disclosure contemplates such methods that allow the submission of the goods and pickup location parameters for a request.

In the preferred embodiment, the delivery location parameter is manually submitted 220 by the user. A delivery location can be suggested using the home or billing address on the purchase confirmation, but can be edited for delivery to other locations such as a job site. For registered users, the delivery location can be selected from the user's past delivery locations or “favorites.”

The system is capable of receiving from the user and populating for the delivery request additional information, including but not limited to time constraints or urgency or other special instructions.

The system validates the delivery request to confirm that all the required information has been provided by the user. Delivery requests that do not have the minimum required information are rejected and the user is informed and asked to add any missing information. Price of delivery is set based on a wide variety of criteria. Price of delivery is established by the routing processor to be included with the delivery request. Price of gas at or near the pickup location and/or delivery location can be collected by the system and used along with the distance between the pickup and delivery location to calculate cost of gas. Alternatively, the cost of gas can be a static rate maintained by the system. Because different goods require different capabilities for delivery, the goods to be delivered (which can include size, weight, cost and fragility of the goods) determine the difficulty of the delivery and therefore affect the price of delivery. Urgency of delivery and other user special requests are also considered by the system when calculating the price. Users can manually increase the price to improve likelihood of acceptance by a deliverer.

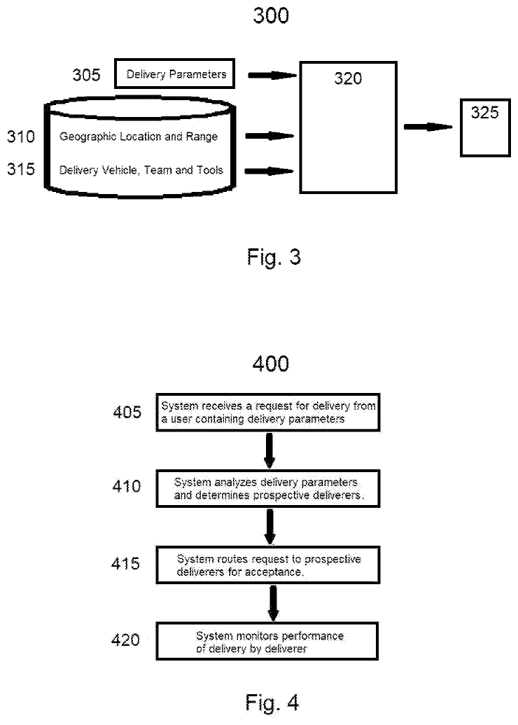

A completed and validated delivery request is sent through a network to a server device where a routing processer utilizes the delivery request parameters to select prospective delivers. As illustrated in FIG. 3, the process of determining the routing of requests to prospective deliverers 300 utilizes the request parameters 305 and deliverer information from the system database. A wide variety of criteria are used to select optimal prospective deliverers from the pool of registered deliverers, and no limitation is intended.

Geographical location and range 310 that a deliverer is willing to travel are part of a deliverer's profile created during registration. Geographical location and range establish the deliverer's radius that the deliverer is willing to travel from his/her location, to the pickup location, and to the dropoff location. Based on cost of gas and travel time, delivers are more likely to accept delivery requests entirely within their radius. In some embodiments, the deliverer specifies whether the pickup location and/or delivery location being within the deliverer's geographic radius is a requirement to receive a delivery request or if it is a preference. The system can be configured to weigh geographic location and range as a factor in selecting optimal deliverers to offer a delivery request to. In other embodiments, geographic location can be dynamically updated using the deliverer's GPS location of their deliverer client device and application.

Delivery vehicle, delivery team members, and tools 315 to perform delivery are part of a deliverer's profile created during registration. Delivery vehicle and tools to perform a delivery establishes the ability of a deliverer to perform the delivery of specific goods. In the preferred embodiment, a deliverer is only offered delivery requests of large appliance or construction supplies if they are physically capable of performing the delivery. The system can be configured to utilize other criteria to determine whether to offer delivery requests to a deliverer, such as a deliverer's experience or expertise with delivery of certain goods, based on their profile and delivery history.

The routing processor 320 determines which prospective deliverers receive a particular delivery requests based on an algorithm that considers several factors. This algorithm includes the deliverer's capability of performing the delivery, the deliverer's vicinity to the delivery and their willingness to perform deliveries that are further away, the deliverer's past history of accepting similar deliveries, and the user's preferences in their profile or the delivery request, which can include deliverers with specialized skills.

Prospective deliverers that are selected to receive a delivery request have the opportunity to accept the request and all its terms to perform the delivery. Deliverers receive the request on their deliverer client device 325 and are able to review the delivery request including the goods, pickup location, delivery location, price. The delivery request can further include calculated mileage, recommended tools or manpower, and other special requests. The user is informed that deliverers have been contacted and are reviewing the request. A deliverer accepts the delivery and the terms of the delivery using his/her deliverer client device. The user is informed of acceptance of a deliverers acceptance of the delivery and an expected completion time of delivery.

A deliverer proceeds to the pickup location to pick up the goods. The deliverer has access to the information and specifications of the goods to be picked up and can therefore confirm the accuracy of the order at the pickup location. The deliverer is able to provide the confirmation number, QR code or other required information and communications that were included in the delivery request in order to receive the goods from the source. The deliverer loads the goods into the vehicle and notifies the system that he/she has picked up the goods. In some embodiments, the deliverer may be required to take a picture of the goods as confirmation that the goods have been successfully loaded. Other means of confirmation of pickup can be utilized and no limitation is intended.

Having picked up the goods, the deliverer proceeds to the delivery location to drop off the goods. The system monitors the deliverer's location and progress during the entire delivery. Timestamps are utilized in order to determine whether the deliverer fulfills the delivery in the specified time requested. Upon arriving at the delivery location, the deliverer unloads and completes delivery of the goods per the terms of the delivery including any special instructions. The user must confirm the successful delivery of the goods, which can be done by the deliverer scanning a QR code that was generated by the system for the delivery request. In situations, where no one is able to receive the delivery, photographic confirmation with the use of GPS to confirm location may be utilized to confirm delivery. Other means of confirmation of delivery can be utilized and no limitation is intended.

As depicted in FIG. 4, the system receives a request for delivery from a user containing delivery parameters 405. The system analyzes the delivery parameters and determines prospective deliverers 410. The system routes the request to prospective delivers for acceptance 415. Once a deliverer accepts the request, the system monitors performance of delivery by the deliverer 420.

The preceding description contains embodiments of the invention and no limitation of the scope is thereby intended. It will be further apparent to those skilled in the art that various modifications and variations can be made in the present invention without departing from the spirit or scope of the invention.

1-8. (canceled)

9. A computer-implemented method for facilitating delivery requests comprising:
receiving a request for delivery wherein the delivery of goods request comprises delivery parameters minimally as goods, the pickup location, and the delivery location;
analyzing the delivery parameters to determine prospective deliverers from a pool of registered deliverers;
routing the delivery request to prospective deliverers for acceptance;
upon acceptance by a deliverer, monitoring performance of the delivery by the deliverer.

10. The method of claim 9, wherein the delivery parameters are determined from user entry.

11. The method of claim 9, wherein the delivery parameters are determined from a confirmation communication.

12. The method of claim 9, wherein the delivery parameters are determined from a combination of user entry and a confirmation number.

13. The method of claim 9, wherein the prospective deliverers are determined from the delivery parameters and deliverer information stored in the system.

14. The method of claim 13, wherein deliverer information stored in the system includes geographic location and range.

15. The method of claim 13, wherein deliverer information stored in the system includes delivery vehicle, delivery team members, and tools.

16. The method of claim 9, analyzing the delivery parameters to determine prospective deliverers from a pool of registered deliverers includes static values maintained by the system.

17. The method of claim 9, analyzing the delivery parameters to determine prospective deliverers from a pool of registered deliverers includes firm requirements to receiving a delivery request.
